(19) United States
(12) Patent Application Publication
(10) Pub. No.: US 2007/0135043 A1
(43) Pub. Date: Jun. 14, 2007

(54) Method and system for accessible contact information on a locked electronic device

(75) Inventors: David J. Hayes, Lake Worth, FL (US); Juan C. Fernandez, Boca Raton, FL (US); Michael J. Thompson, Davie, FL (US); Nathan A. Stone, Provo, UT (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/299,954

(22) Filed: Dec. 12, 2005

(51) Int. Cl. H04B 1/06

(52) U.S. Cl. 455/26.1; 455/411

(57) ABSTRACT

An electronic device (10 or 300) and method (400) can include a storage medium (14, 304, or 306) having at least a predetermined contact number (15) designated as an emergency contact number and a processor (302). The processor can be programmed to place the electronic device or a portion (14 or 18) of the electronic device in a locked mode and enable (408) electronic access to any predetermined contact number designated as an emergency contact number notwithstanding the locked mode. The electronic device can be for example a cellular phone, a smart phone, a cordless home phone, a personal digital assistant, a wireless messaging device, an MP3 player, a laptop computer, or a lockable solid state memory device. The electronic device can be a wireless communication device and the emergency contact number can be contained in an electronic phonebook (19) within the storage medium.

### FIELD

This invention relates generally to communication devices, and more particularly to a method and system of providing access to certain contact information notwithstanding a locked status.

### BACKGROUND

With the ubiquitous use of cell-phones and the increased awareness of disasters (natural & terrorist), there is a major push by the emergency responder community for people to include emergency contact numbers in their phones. These are known as ICE contacts (In Case of Emergency). The current suggestion is to add ICE to the beginning of these contacts in your phone. Unfortunately, with increased incidents of identity theft and the increased awareness of such thefts, many phone users desire to lock or password protect their phones so that contact lists and other personal information are not accessible. In many instances, an ICE contact would be considered personal to a particular individual. Further complicating easy accessibility to emergency responders is the existence of a myriad of phone manufacturers and models and user interfaces such that getting to particular phone book entries can vary greatly from phone to phone. Finding the phone book entries and specifically the ICE entries can be a time consuming task, when seconds count.

At the direction of public safety organizations, phone users are entering emergency contact numbers in their contact list, but if the phone is locked at the time of an emergency and the user is unconscious, there is no easy way to get the information. In many file systems, particularly computing devices, individual files can have access control settings that make them public or varying degrees of private. In these systems, all entries typically default to a certain setting (typically based on the folder in which they are created) and the user must manually adjust the access control setting of the file. Such a system would likely still cause accessibility problems for emergency responders.

### SUMMARY

Embodiments in accordance with the present invention can provide easy access to a predetermined contact number such as an emergency contact number in an electronic device notwithstanding the electronic device or portions of the electronic device being in a locked mode.

In a first embodiment of the present invention, a method of providing limited access to a predetermined contact number can include placing an electronic device or portions of the electronic device in a locked mode and enabling electronic access to the predetermined contact number notwithstanding the locked mode. Access to the predetermined contact number can be enabled by depressing a predetermined key on a keypad on the electronic device. Note, the predetermined key can be a dedicated key for this purpose on the electronic device. The method can further include the step of storing the predetermined contact number in a memory within the electronic device. The predetermined contact number can be stored in a predetermined emergency contact field where access to the predetermined emergency contact field is accessible notwithstanding the locked mode. The predetermined contact number can be designated as an emergency contact number and the method can further store and enable access to any predetermined contact number designated as an emergency contact number notwithstanding a locked mode for the electronic device. Optionally, the method can enable the ability to make a communication (such as sending a call, a message, or an email) to the predetermined contact number from the electronic device without providing visual access to the predetermined contact number.

In a second embodiment of the present invention, an electronic device can include a storage medium having at least a predetermined contact number designated as an emergency contact number and a processor coupled to the storage medium. The processor can be programmed to place the electronic device or a portion of the electronic device in a locked mode and enable electronic access to any predetermined contact number designated as an emergency contact number notwithstanding the locked mode. The electronic device can be for example a cellular phone, a smart phone, a cordless home phone, a personal digital assistant, a wireless messaging device, an MP3 player, a laptop computer, or a lockable solid state memory device. The processor can be programmed to enable access by depressing a predetermined key (such as a dedicated key) on a keypad on the electronic device. The emergency contact number can be electronically stored in the storage medium within the electronic device. In one embodiment, the electronic device can be a wireless communication device and the emergency contact number can be contained in an electronic phonebook within the storage medium and identified by the term ICE for “In case of emergency”. The electronic device can be further programmed to include a predetermined emergency contact field for storing the predetermined contact number which can be accessible notwithstanding the locked mode. Note, the processor can be programmed to store and enable access to any predetermined contact number designated as an emergency contact number notwithstanding a locked mode for the electronic device. Optionally, the processor can be programmed to enable the ability to make a communication with the predetermined contact number from the wireless communication device without providing visual access to the predetermined contact number.

In a third embodiment of the present invention, a wireless communication device can include a transceiver, a storage medium having stored therein at least a predetermined contact number designated as an emergency contact number, and a processor coupled to the storage medium and the transceiver. The processor can be programmed to place the wireless communication device in a locked mode and to enable electronic access to any predetermined contact number designated as an emergency contact number notwithstanding the locked mode. The processor can be further programmed to electronically store the emergency contact number in an electronic phonebook within a storage identity module (SIM) serving as the storage medium and the emergency contact number is identified by the term ICE for “In case of emergency”.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is an illustration of an electronic device such as a cellular phone that can be placed in a locked mode and still enable electronic access to an emergency contact number notwithstanding the locked mode in accordance with an embodiment of the present invention.

FIG. 2 is an illustration of a display or user interface of the electronic device of FIG. 1 in a locked mode, but still providing access to a predetermined or emergency contact number in accordance with an embodiment of the present invention.

FIG. 3 is a block diagram of an electronic device such a wireless communication device in accordance with an embodiment of the present invention.

FIG. 4 is a flow chart illustrating a method of providing limited access to a predetermined contact number in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

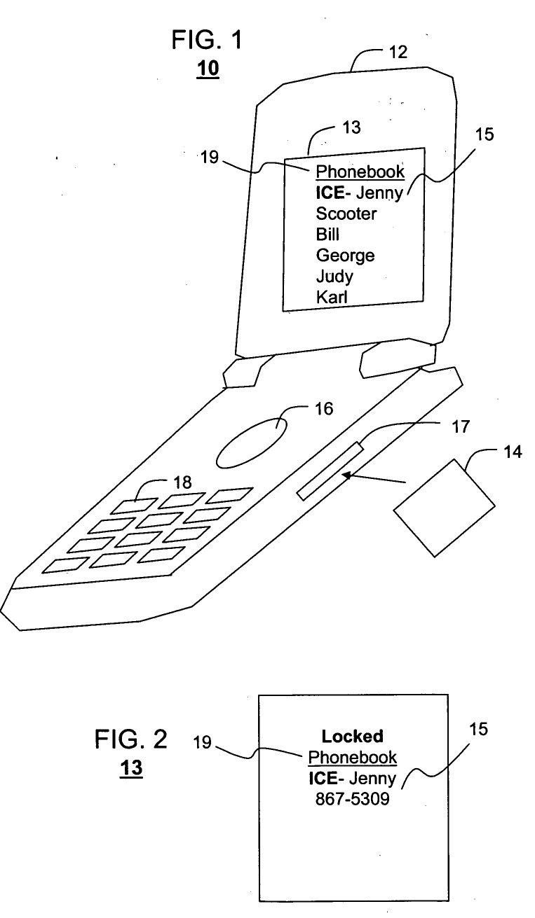

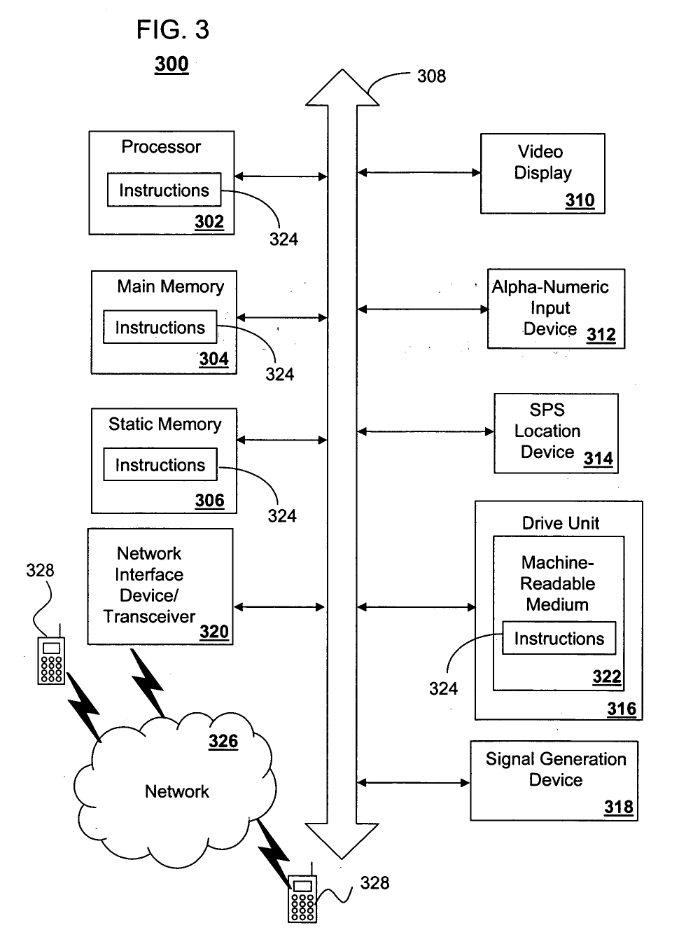

Referring to FIG. 1, an electronic device 10 such as a cellular phone, a smart phone, a cordless home phone, a personal digital assistant, a wireless messaging device, an MP3 player, a laptop computer, or a lockable solid state memory device can include a storage medium 14 (such as memory in the form of a memory stick, a subscriber identity module (SIM) card, flash memory, embedded memory, etc.) having at least a predetermined contact number 15 designated as an emergency contact number and a processor (shown in FIG. 3) coupled to the storage medium. The designation for an emergency contact number can be any designation and is not limited to the term “ICE” for “in case of emergency” as shown. The name given to the emergency contact designation and which contacts are designated as emergency contacts can be user selectable. The electronic device 10 can be a wireless communication device 12 having a display or user interface 13 wherein the predetermined contact number 15 can be visible as part of a electronic phonebook 19. The wireless communication device 12 can further include a key or keypad 18 and/or a dedicated key 16 that can provide user selectable access to the predetermined or emergency contact number 15 by depressing any one of the keys 18, or the dedicated key 16. Optionally, a predetermined pattern of key presses such as the pressing of the “*” or “#” key for 2 seconds or twice in a row might also be used as one of many means for providing access to the emergency contact number notwithstanding the locked mode. Of course, any other user input including detection of sound by a microphone in the wireless communication device 12 can be used to automatically enable access to the predetermined or emergency contact number 15 as well. Note, if the wireless device 12 includes a SIM card, it can include a slot 17 for interfacing with the SIM card.

The processor in the electronic device 10 can be programmed to place the electronic device 10 or a portion (such as the keypad 18 or SIM card) of the electronic device in a locked mode that would effectively prevent access to all personal information except for the designated emergency contact number 15. The processor would further enable electronic access to any predetermined contact number 15 designated as an emergency contact number notwithstanding the locked mode as illustrated in the display 15 in FIG. 2. Optionally, the processor can be programmed to enable the ability to make a communication with the predetermined contact number from the wireless communication device without providing visual access to the predetermined contact number. In other words, the display may only display the term “ICE” or “Contact Emergency Number?” without providing the actual phone number or contact information and the wireless communication device 12 can be enabled to contact such embedded contact number despite being in a locked mode. Further note that embodiments within contemplation of the scope of the claims herein do not necessarily require a display. Enabling access to the emergency contact number in this context can mean extracting or utilizing the emergency contact number in any known manner including dialing the emergency contact number, audibly announcing the contact number (using text to speech (TTS) or voice synthesis) or coupling the device to another device for extraction and viewing of the contact information. For example, the device 12 can include an infrared transceiver or a USB port that can enable extraction of the emergency contact information by another device notwithstanding a locked condition for the device 12.

Further refinements to the embodiment herein can include adding a field to the contact list or phone book that designates a contact as the emergency contact or an ICE contact. In such an embodiment, the term ICE can be automatically pre-pended to the contact name and made available even when the phonebook is otherwise inaccessible. The wireless device can also be programmed to automatically recognize an ICE contact upon entry (by checking the starting characters) and automatically make it available even when the phonebook is otherwise inaccessible. The user can also be prompted to make the ICE contact always available and readable. Additionally, a standard can be created that is the same (or at least similar) across every phone model and manufacturer that allows instant access to the ICE entries of a phone. For example, as discussed above, if a paramedic presses and holds the # key for 2 seconds, the ICE entries will be shown regardless of whether or not the phone is locked.

Referring to FIG. 3, an electronic product or wireless device in the form of a computer system 300 can include a processor 302 (e.g., a central processing unit (CPU), a graphics processing unit (GPU, or both), a main memory 304 and a static memory 306, which communicate with each other via a bus 308. The computer system 300 may further include a video display unit 310 (e.g., a liquid crystal display (LCD), a flat panel, a solid state display, or a cathode ray tube (CRT)). The computer system 300 may include an input device 312 (e.g., a keyboard or keypad), a satellite position system device 314 (e.g., a GPS receiver), a disk drive unit 316, a signal generation device 318 (e.g., a speaker or remote control or microphone) and a network interface device 320.

The disk drive unit 316 may include a machine-readable medium 322 on which is stored one or more sets of instructions (e.g., software 324) embodying any one or more of the methodologies or functions described herein, including those methods discussed below. The instructions 324 may also reside, completely or at least partially, within the main memory 304, the static memory 306, and/or within the processor 302 during execution thereof by the computer system 300. The main memory 304 and the processor 302 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 324, or that which receives and executes instructions 324 from a propagated signal so that a device connected to a network environment 326 can send or receive voice, video or data, and to communicate over the network 326 using the instructions 324 to one or more communication devices 328. The instructions 324 may further be transmitted or received over a network 326 via the network interface device 320.

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

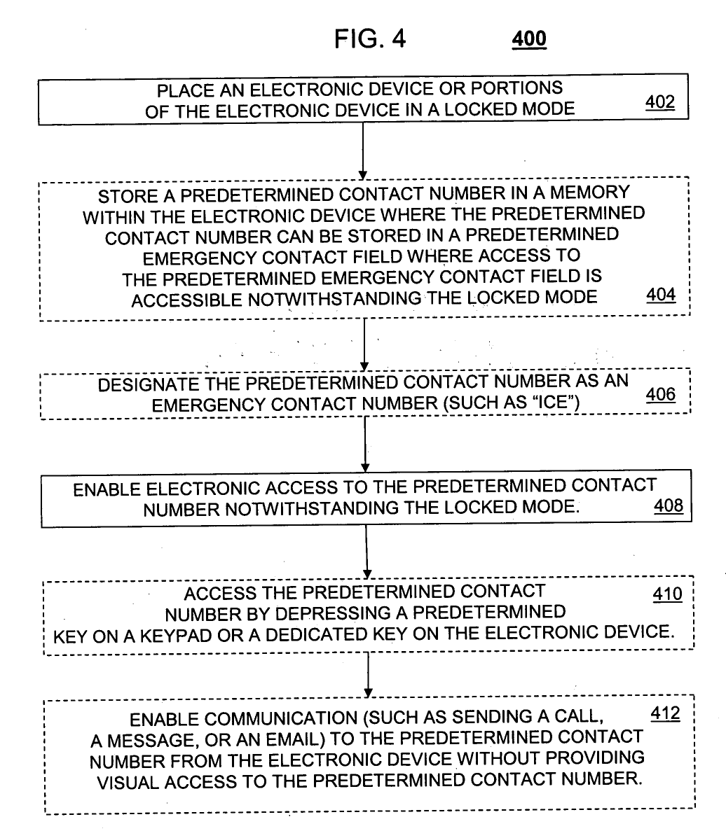

Referring to FIG. 4, a flow chart illustrating a method 400 of providing limited access to a predetermined contact number can include the step 402 of placing an electronic device or portions of the electronic device in a locked mode and enabling electronic access to the predetermined contact number notwithstanding the locked mode at step 408. The method 400 can further optionally include the step 404 of storing a predetermined contact number in a memory within the electronic device where the predetermined contact number can be stored in a predetermined emergency contact field where access to the predetermined emergency contact field is accessible notwithstanding the locked mode. At step 406, the predetermined contact number can be designated as an emergency contact number (such as “ICE”). Access to the predetermined contact number can be achieved at step 410 by depressing a predetermined key on a keypad or a dedicated key on the electronic device. In another optional step 412, communication (such as sending a call, a message, or an email) to the predetermined contact number from the electronic device without providing visual access to the predetermined contact number can be enabled.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of providing limited access to a predetermined contact number, comprising the steps of:
placing an electronic device or a portion of the electronic device in a locked mode; and
enabling electronic access to the predetermined contact number notwithstanding the locked mode.

2. The method of claim 1, wherein the step of enabling comprises enabling access by depressing a predetermined key on a keypad on the electronic device.

3. The method of claim 1, wherein the step of enabling comprises enabling access to the predetermined contact number by depressing a dedicated key on the electronic device.

4. The method of claim 1, wherein the method further comprises the step of electronically storing the predetermined contact number in a memory within the electronic device.

5. The method of claim 1, wherein the method further comprises the step of creating a predetermined emergency contact field for storing the predetermined contact number.

6. The method of claim 5, wherein the method further comprises the step of enabling access to the predetermined emergency contact field notwithstanding the locked mode.

7. The method of claim 1, wherein the predetermined contact number is designated as an emergency contact number and the method further comprises the step of storing and enabling access to any predetermined contact number designated as an emergency contact number notwithstanding a locked mode for the electronic device.

8. The method of claim 1, wherein the step of enabling access comprises enabling the ability to make a communication with the predetermined contact number from the electronic device without providing visual access to the predetermined contact number.

9. An electronic device, comprising:
a storage medium having stored therein at least a predetermined contact number designated as an emergency contact number;
a processor coupled to the storage medium, wherein the processor is programmed to:
place the electronic device or a portion of the electronic device in a locked mode; and
enable electronic access to any predetermined contact number designated as an emergency contact number notwithstanding the locked mode.

10. The electronic device of claim 9, wherein the electronic device is a cellular phone, a smart phone, a cordless home phone, a personal digital assistant, a wireless messaging device, an MP3 player, a laptop computer, or a lockable solid state memory device.

11. The electronic device of claim 9, wherein the processor is programmed to enable access by depressing a predetermined key on a keypad on the electronic device.

12. The electronic device of claim 9, wherein the processor is programmed to enable access by depressing a dedicated key on the electronic device.

13. The electronic device of claim 9, wherein the processor is further programmed to electronically store the emergency contact number in the storage medium within the electronic device.

14. The electronic device of claim 13, wherein the electronic device is a wireless communication device and the emergency contact number is contained in an electronic phonebook within the storage medium and identified by the term ICE for “In case of emergency”.

15. The electronic device of claim 9, wherein the electronic device is further programmed to include a predetermined emergency contact field for storing the predetermined contact number.

16. The electronic device of claim 9, wherein the processor is further programmed to enable access to the predetermined emergency contact field notwithstanding the locked mode.

17. The electronic device of claim 9, wherein processor is further programmed to store and enable access to any predetermined contact number designated as an emergency contact number notwithstanding a locked mode for the electronic device.

18. The electronic device of claim 9, wherein processor is further programmed to enable the ability to make a communication with the predetermined contact number from the wireless communication device without providing visual access to the predetermined contact number.

19. A wireless communication device, comprising:
a transceiver
a storage medium having stored therein at least a predetermined contact number designated as an emergency contact number;
a processor coupled to the storage medium and the transceiver, wherein the processor is programmed to:
place the wireless communication device in a locked mode; and
enable electronic access to any predetermined contact number designated as an emergency contact number notwithstanding the locked mode.

20. The wireless communication device of claim 19, wherein the processor is further programmed to electronically store the emergency contact number in an electronic phonebook within a storage identity module (SIM) serving as the storage medium and the emergency contact number is identified by the term ICE for “In case of emergency”.
